(19) United States
(12) Patent Application Publication
(10) Pub. No.: US 2025/0087688 A1
(43) Pub. Date: Mar. 13, 2025

(54) METHOD OF MANUFACTURING ACTIVE MATERIAL LAYER FOR BATTERY, ACTIVE MATERIAL LAYER FOR BATTERY, AND BATTERY

(71) Applicant: TOYOTA JIDOSHA KABUSHIKI KAISHA, Toyota-shi (JP)

(72) Inventor: Minehiro FUNATO, Toyota-shi (JP)

(73) Assignee: TOYOTA JIDOSHA KABUSHIKI KAISHA, Toyota-shi (JP)

(21) Appl. No.: 18/792,727

(22) Filed: Aug. 2, 2024

(30) Foreign Application Priority Data
Sep. 8, 2023 (JP) 2023-146450

(51) Int. Cl. H01M 4/583; H01M 4/02; H01M 4/04; H01M 4/1393; H01M 4/62

(52) U.S. Cl. CPC H01M 4/583; H01M 4/0471; H01M 4/1393; H01M 4/622; H01M 2004/021; H01M 2004/027

(57) ABSTRACT

A method of manufacturing an active material layer for a battery, the method including: preparing an active material layer, the active material layer containing a binder and an active material; and irradiating a nanosecond pulsed laser onto the active material layer under a condition of an inputted heat amount being greater than or equal to 0.005 J/mm² and less than or equal to 0.050 J/mm².

### CROSS-REFERENCE TO RELATED APPLICATION

This application is based on and claims priority under 35 USC 119 from Japanese Patent Application No. 2023-146450 filed on Sep. 8, 2023, the disclosure of which is incorporated by reference herein.

### BACKGROUND

### Technical Field

The present disclosure relates to a method of manufacturing an active material layer for a battery, an active material layer for a battery, and a battery.

### Related Art

Conventionally, in liquid-type batteries that use an electrolyte solution, an active material layer that contains a binder and an active material is used.

For example, Japanese Patent Application Laid-Open (JP-A) No. 2011-171020 discloses a non-aqueous electrolyte solution battery having an electrode group, an exterior material, and a non-aqueous electrolyte solution. The electrode group has a positive electrode, a negative electrode and a separator. The positive electrode has a positive electrode collector, and a positive electrode layer that contains a positive electrode active material and a binder and is formed on the positive electrode collector. The negative electrode has a negative electrode collector, and a negative electrode layer that contains a negative electrode active material and a binder and is formed on the negative electrode collector. The separator is interposed between the positive electrode layer and the negative electrode layer, and is wound on both the positive electrode and the negative electrode. At least one of the positive electrode layer and the negative electrode layer has plural permeation promoting portions that are formed on the respective surface sides thereof so as to connect both long sides(S), and at which the amount of the binder is less than at the surface sides of other regions (R), and that promote the permeation of the non-aqueous electrolyte solution from the surface sides of the regions (R).

JP-A No. 2011-171020 discloses a method of forming regions, at which the amount of the binder is low, at the surfaces of the electrode layers of a battery that uses a non-aqueous electrolyte solution, by a CW laser. However, the active materials and the like are eliminated from the electrode layers due the laser irradiation, and the amount of the active materials decreases, and as a result, there are cases in which the battery capacity of the battery decreases.

Further, the ability of the electrolyte solution to permeate into the active material layers at the battery affects the resistance of the battery. Therefore, it is desirable to decrease the resistance of the battery by improving the ability of the electrolyte solution to permeate into the active material layers.

### SUMMARY

The present disclosure was made in view of the above-described circumstances, and an object thereof is to provide a method of manufacturing an active material layer for a battery, an active material layer for a battery, and a battery that has the active material layer for a battery, which can reduce the resistance of the battery while suppressing a decrease in the battery capacity of the battery.

Means for addressing the above-described topic include the following aspects.

<1>

A method of manufacturing an active material layer for a battery, including:
a step of preparing an active material layer that contains a binder and an active material; and
an irradiating step of irradiating a nanosecond pulsed laser onto the active material layer under a condition of an inputted heat amount being greater than or equal to 0.005 J/mm² and less than or equal to 0.050 J/mm².
   <2>

The method of manufacturing an active material layer for a battery of <1>, wherein the irradiating step is a step of irradiating a nanosecond pulsed laser under conditions of output power being greater than or equal to 1.25 W and less than or equal to 5 W, and an overlap ratio being greater than or equal to 0% and less than or equal to 63%.

<3>

An active material layer for a battery which active material layer contains a binder and an active material,
wherein an average particle diameter of the binder in an image of a surface that is acquired by EPMA mapping obtained with staining the binder is greater than an average particle diameter of the binder in an image of a cross-section of a depth of 20 μm that is acquired by EPMA mapping.
   <4>

An active material layer for a battery which active material layer contains a binder and an active material,
wherein an average particle diameter of the binder in an image of a surface that is acquired by EPMA mapping obtained with staining the binder is greater than or equal to 30 μm.
   <5>

A battery including the active material layer for a battery of <3> or <4> as at least one of a positive electrode active material layer or a negative electrode active material layer.

In accordance with the present disclosure, there are provided a method of manufacturing an active material layer for a battery, an active material layer for a battery, and a battery that has the active material layer for a battery, which can reduce the resistance of the battery while suppressing a decrease in the battery capacity of the battery.

### BRIEF DESCRIPTION OF THE DRAWINGS

Exemplary embodiments of the present invention will be described in detail based on the following figures, wherein:

FIG. 1 is a graph illustrating results of measuring the change in mass (mass loss (%)) of active material layers before and after nanosecond pulsed laser irradiation in Examples and Comparative Examples; and

FIG. 2 is a graph illustrating results of measuring battery resistance in the Examples and a Reference Example.

### DETAILED DESCRIPTION

An embodiment that is an example of the present disclosure is described hereinafter. This description and the Examples exemplify embodiments and do not limit the scope of the invention.

In numerical value ranges that are expressed in a stepwise manner in the present specification, the maximum value or the minimum value listed in a given numerical value range may be substituted by the maximum value or the minimum value of another numerical value range that is expressed in a stepwise manner. Further, in the numerical value ranges put forth in the present specification, the maximum value or the minimum value of a given numerical value range may be substituted by a value set forth in the Examples.

Each component may contain plural types of the corresponding material. When listing the amounts of the respective components within a composition, in a case in which there are plural types of materials that correspond to a component within the composition, the amount of that component means the total amount of the plural types of materials existing within the composition, unless otherwise indicated.

“Step” is not only an independent step and includes steps that, even in a case in which that step cannot be clearly distinguished from another step, achieve the intended object of that step.

### <Method of Manufacturing Active Material Layer for Battery>

A method of manufacturing an active material layer for a battery relating to an embodiment of the present disclosure includes a step of preparing an active material layer that contains a binder and an active material, and an irradiating step of irradiating a nanosecond pulsed laser onto the active material layer under the condition of the inputted heat amount being greater than or equal to 0.005 J/mm² and less than or equal to 0.050 J/mm².

The method of manufacturing an active material layer for a battery relating to the embodiment of the present disclosure applies heat locally to the surface of the active material layer by a nanosecond pulsed laser, and, at that time, applies an inputted heat amount of greater than or equal to 0.005 J/mm². Therefore, the binder at the surface of the active material layer is melted due to the heat and flocculates. Due thereto, the reaction surface at the surface of the active material layer is ensured, and paths for permeation of the electrolyte solution into the active material layer are ensured. As a result, the resistance of a battery that has this active material layer can be reduced.

Further, a nanosecond pulsed laser is adopted as the laser that is irradiated onto the surface of the active material layer, and the inputted heat amount at the time of irradiating the nanosecond pulsed laser is kept to less than or equal to 0.050 J/mm². Namely, heat is applied locally to the surface of the active material layer by a nanosecond pulsed laser, and the total amount of heat thereof is suppressed. Due thereto, the active material being eliminated from the active material layer due to laser irradiation is suppressed, and the mass loss of the active material is suppressed. Therefore, a decrease in the battery capacity of a battery that has this active material layer is suppressed.

Further, by adopting a nanosecond pulsed laser as the laser that is irradiated onto the surface of the active material layer, the binder being eliminated from the active material layer also is suppressed. Therefore, the adhesive force at the active material layer is maintained, and the generation of foreign matter from the active material layer also is suppressed.

The method of manufacturing an active material layer for a battery relating to the embodiment of the present disclosure is described hereinafter step-by-step.

### Step of Preparing Active Material Layer

The method of manufacturing an active material layer for a battery relating to the embodiment of the present disclosure has a step of preparing an active material layer that contains a binder and an active material.

Note that any of a negative electrode active material layer and a positive electrode active material layer can be used as the active material layer. The negative electrode active material layer and the positive electrode active material layer can be formed by conventionally known methods. For example, the active material layer can be formed by coating and drying a solution containing the raw materials of the active material layer.

The active material, the binder and the like are described hereinafter with respect to the negative electrode active material layer and the positive electrode active material layer, separately.

### Negative Electrode Active Material Layer

Graphite-based carbons such as natural graphite, artificial graphite, amorphous coated graphite and the like are examples of the negative electrode active material. The proportion of graphite contained in the graphite-based carbon is greater than or equal to approximately 50 mass %, and preferably greater than or equal to 80 mass %.

Examples of the binder contained in the negative electrode active material are rubbers such as styrene-butadiene copolymer (SBR) and the like, and vinyl halide resins such as polyvinylidene fluoride (PVdF) and the like.

The negative electrode active material layer may further contain other components such as a thickener or the like. Examples of the thickener are celluloses such as carboxymethylcellulose (CMC) and the like.

### Positive Electrode Active Material Layer

Examples of the positive electrode active material are lithium-nickel-cobalt-manganese complex oxides (hereinafter simply called “LNCM” upon occasion). The simplest LNCM is expressed by the general formula LiNiₓCo_{y}Mn_{z}O₂ (where x, y, z in the formula are 0<x<1, 0<y<1, 0<z<1, and x+y+z=1). In addition to Li, Ni, Co and Mn, LNCM may contain other added elements such as, for example, transition metal elements other than Ni, Co, Mn, and main group metal elements other than Li, and the like. LNCM has a layered crystal structure. LNCM exceeds 50 mass % of the entire positive electrode active material, and it is good for LNCM to be contained in an amount of 80-100 mass % for example. The positive electrode active material may be structured by LNCM alone.

Examples of other positive electrode active materials are lithium-nickel complex oxides, lithium-cobalt complex oxides, lithium-nickel-manganese complex oxides and the like.

Examples of the binder contained in the positive electrode active material layer are vinyl halide resins such as polyvinylidene fluoride (PVdF) and the like.

The positive electrode active material layer may contain other components such as a conductive material or the like. Examples of conductive materials are carbon that is hard to graphitize, carbon that is easy to graphitize such as carbon black or the like, graphite, and the like.

### Irradiating Step

Next, in the irradiating step, a nanosecond pulsed laser is irradiated onto the active material layer under the condition of the inputted heat amount being greater than or equal to 0.005 J/mm² and less than or equal to 0.050 J/mm².

Note that a nanosecond pulsed laser means a pulsed laser whose pulse width is greater than or equal to 1 ns and less than or equal to 500 ns. The pulse width of the nanosecond pulsed laser is preferably greater than or equal to 1 ns and less than or equal to 100 ns.

### Inputted Heat Amount

The inputted heat amount of the nanosecond pulsed laser that is irradiated onto the active material layer in the irradiating step is greater than or equal to 0.005 J/mm² and less than or equal to 0.050 J/mm².

By making the inputted heat amount be greater than or equal to 0.005 J/mm², the binder at the surface of the active material layer is melted and flocculates, and paths for permeation of the electrolyte solution into the active material layer are ensured. Due thereto, the resistance of the battery that has the active material layer can be reduced. On the other hand, by making the inputted heat amount be less than or equal to 0.050 J/mm², the active material being eliminated from the active material layer due to the laser irradiation is suppressed, and a decrease in the battery capacity of the battery having the active material layer is suppressed.

The minimum value of the inputted heat amount is more preferably greater than or equal to 0.010 J/mm², and even more preferably greater than or equal to 0.015 J/mm². On the other hand, the maximum value of the inputted heat amount is more preferably less than or equal to 0.040 J/mm², and even more preferably less than or equal to 0.030 J/mm².

The inputted heat amount of the nanosecond pulsed laser can be controlled by adjusting the output power and the overlap ratio for example.

### Output Power

From the standpoint of reducing the resistance of the battery while suppressing a decrease in the battery capacity of the battery, the output power of the nanosecond pulsed laser is preferably greater than or equal to 1.25 W and less than or equal to 5.00 W, and is more preferably greater than or equal to 1.50 W and less than or equal to 4.50 W, and is even more preferably greater than or equal to 2.00 W and less than or equal to 3.50 W.

### Overlap Ratio

From the standpoint of reducing the resistance of the battery while suppressing a decrease in the battery capacity of the battery, the overlap ratio at the time of irradiating the nanosecond pulsed laser is preferably greater than or equal to 0% and less than or equal to 63%, and is more preferably greater than or equal to 0% and less than or equal to 55%, and is even more preferably greater than or equal to 0% and less than or equal to 30%.

Here, the overlap ratio means the proportion of the surface area of the regions where the nanosecond pulsed laser is irradiated overlappingly, and is expressed by the following formula.

Formula: (regions where laser is irradiated overlappingly)/((regions where laser is irradiated overlappingly)+(regions where laser is not irradiated overlappingly))

A nanosecond pulsed laser is a pulsed laser whose pulse width is of a shortness of the nanosecond level. By repeatedly carrying out irradiating in a short time period while moving the irradiating position of the laser slightly, laser irradiation is carried out over the entire region that is the object of irradiation. A region where the laser is irradiated overlappingly means a region where the laser is irradiated so as to overlap the irradiated region of the previous time because the movement of the irradiating position is small, during laser irradiation that is carried out repeatedly while moving the irradiating position. For example, in a case in which irradiation is carried out repeatedly without moving the irradiating position at all, the overlap ratio is 100%. In a case in which irradiation is carried out repeatedly while moving the irradiating position so as to miss the region irradiated by the laser irradiation of one time, the overlap ratio is 0%. The overlap ratio can be controlled by, for example, adjusting the moving distance or the like at the time of the laser irradiation that is carried out repeatedly.

### <Active Material Layer for Battery>

### First Active Material Layer

In the present disclosure, an active material layer for a battery relating to a first embodiment (simply called “first active material layer”) contains a binder and an active material, and the average particle diameter of the binder in an image of the surface that is acquired by EPMA mapping obtained with staining the binder is greater than the average particle diameter of the binder in an image of a cross-section of a depth of 20 μm that is acquired by EPMA mapping.

Average particle diameter [A] of the binder at the surface of the active material layer being greater than average particle diameter [B] of the binder at a cross-section of a depth of 20 μm from the surface means that the binder flocculates at the surface of the active material layer. Therefore, the reaction surface at the surface of the active material layer is ensured, paths for permeation of the electrolyte solution into the active material layer are ensured, and, as a result, the resistance of the battery that has this active material layer can be reduced.

Note that the first active material layer can be obtained by, for example, the above-described method of manufacturing an active material layer for a battery relating to an embodiment of the present disclosure.

### Second Active Material Layer

In the present disclosure, an active material layer for a battery relating to a second embodiment (simply called “second active material layer”) contains a binder and an active material, and the average particle diameter of the binder in an image of the surface that is acquired by EPMA mapping obtained with staining the binder is greater than or equal to 30 μm.

The average particle diameter [A] of the binder at the surface of the active material layer being large at greater than or equal to 30 μm means that the binder flocculates at the surface of the active material layer. Therefore, the reaction surface at the surface of the active material layer is ensured, paths for permeation of the electrolyte solution into the active material layer are ensured, and, as a result, the resistance of the battery that has this active material layer can be reduced.

In the second active material layer, the average particle diameter [A] of the binder at the surface is greater than or equal to 30 μm, and is preferably greater than or equal to 40 μm, and is more preferably greater than or equal to 45 μm. Note that the maximum value of the average particle diameter [A] of the binder is, for example, preferably less than or equal to 100 μm, and more preferably less than or equal to 70 μm.

Note that the second active material layer can be obtained by, for example, the above-described method of manufacturing an active material layer for a battery relating to an embodiment of the present disclosure.

The method of measuring the average particle diameter [A] of the binder at the surface of the active material layer is described here.

First, staining (e.g., osmium (Os) staining) of the active material layer is carried out in accordance with the binder that is contained. Next, an EPMA (Electron Probe Micro Analysis) mapping image of the surface of the active material layer after the staining is acquired. Data of the luminance that is the highest 10% is computed from the mapping image that is obtained, and binarization processing is carried out by setting this luminance data as the threshold value. The particle diameters of particles of the binder (which means the lengths of the longest portions in the image of the particles of the target binder) are measured from the image after the binarization. This measurement is carried out on 20 binder particles, and the arithmetic mean value thereof is used as the average particle diameter.

Note that, in the measuring of the average particle diameter [B] of the binder in a cross-section of a depth of 20 μm from the surface, the cross-section at the depth of 20 μm from the surface is exposed by a method such as cutting or the like, and then the average particle diameter is determined in the same way as the above-described method of measuring the average particle diameter [A].

### <Battery>

A battery relating to an embodiment of the present disclosure has the above-described first active material layer or second active material layer as at least one of the positive electrode active material layer and negative electrode active material layer. The battery has, for example, a negative electrode, a positive electrode, a separator, and an electrolyte solution.

### (Electrolyte Solution)

### Solvent

The electrolyte solution contains a solvent (a non-aqueous solvent) and an electrolyte.

Examples of the solvent (the non-aqueous solvent) are N,N-diethyl-N-methyl-N-(2-methoxyethyl) ammonium bis(fluorosulfonyl)imide (DEME), 1-ethyl-3-methylimidazolium bis(fluorosulfonyl)imide (EMI), 1-ethyl-2,3-dimethylimidazolium bis(fluorosulfonyl)imide (DEMI-FSI), and the like.

### Electrolyte

Lithium salts are examples of the electrolyte in the electrolyte solution. Examples of lithium salts are lithium bis(fluorosulfonyl)imide (LiFSI), LiPF₆ (lithium hexafluorophosphate), lithium tetrafluoroborate (LiBF₄), Li[N(CF₃SO₂)₂], and the like. The amount of the electrolyte may be, for example, 1.0-2.0 mol/L, and is preferably 1.0-1.5 mol/L.

In addition to the solvent and the electrolyte, the electrolyte solution may contain various additives such as, for example, thickeners, film-forming agents, gas generating agents, and the like. The electrolyte is typically a non-aqueous electrolyte solution that is in a liquid state at ordinary temperatures (e.g., 25±10° C.). The electrolyte solution typically assumes a liquid state in usage environments of batteries (e.g., environments of temperatures of −20-+60° C.).

### (Negative Electrode)

The negative electrode has, for example, a negative electrode collector, and a negative electrode active material layer adhered on the negative electrode collector. A conductive member formed from a metal having good conductivity (e.g., copper) is suitable as the negative electrode collector. For example, the above-described first active material layer or second active material layer is used as the negative electrode active material layer.

### (Positive Electrode)

The positive electrode has, for example, a positive electrode collector, and a positive electrode active material layer adhered on the positive electrode collector. A conductive member formed from a metal having good conductivity (e.g., aluminum) is suitable as the positive electrode collector. For example, the above-described first active material layer or second active material layer is used as the positive electrode active material layer.

### (Separator)

The separator is an electrically insulating, porous film. The separator electrically isolates the positive electrode and the negative electrode. The separator may have a thickness of 5-30 μm for example. The separator can be structured by, for example, a porous polyethylene (PE) film, a porous polypropylene (PP) film, or the like. The separator may be a multilayer structure. For example, the separator may be structured by a porous PP film, a porous PE film, and a porous PP film being layered in that order. The separator may have a heat-resistant layer on the surface thereof. The heat-resistant layer contains a heat-resisting material. Examples of the heat-resisting material are metal oxide particles such as alumina or the like, high melting point resins such as polyimide or the like, and the like.

### (Applications)

Examples of the application of the battery are, for example, the power source of a hybrid vehicle (HEV), a plug-in hybrid vehicle (PHEV), an electric vehicle (BEV) or the like.

### EXAMPLES

The present disclosure is described hereinafter on the basis of Examples, but is not in any way limited to these Examples. Note that, in the following explanation, “parts” and “%” all are based on mass, unless otherwise indicated.

### Examples 1 Through 4, Comparative Examples 1 and 2

In the Examples and Comparative Examples, a laser was irradiated onto the surfaces of active material layers having the following compositions, while changing the inputted heat amount by adjusting the output power and overlap ratio of the irradiated nanosecond pulsed laser as per Table 1.

### (Irradiating Conditions)

a) laser pulse width: 50 ns, output power: 2.5 W-5 W, overlap ratio: 0%-63%
b) composition of active material layer: negative electrode active material=graphite, binder=styrene-butadiene copolymer (SBR), thickener=carboxymethylcellulose (CMC), conductive material: carbon nanotubes (CNT)

TABLE 1

| | | | | | Comp. | Comp. |
|---|---|---|---|---|---|---|
| | Ex. 1 | Ex. 2 | Ex. 3 | Ex. 4 | Ex. 1 | Ex. 2 |
| output power | 2.5 | 2.5 | 2.5 | 2.5 | 3.75 | 5 |
| [W] | | | | | | |
| overlap ratio | 0 | 25 | 50 | 63 | 63 | 63 |
| (%) | | | | | | |
| inputted heat | 0.005 | 0.01 | 0.022 | 0.04 | 0.06 | 0.08 |
| amount | | | | | | |
| [J/mm²] | | | | | | |

### <Evaluation>

### (1) Mass Loss

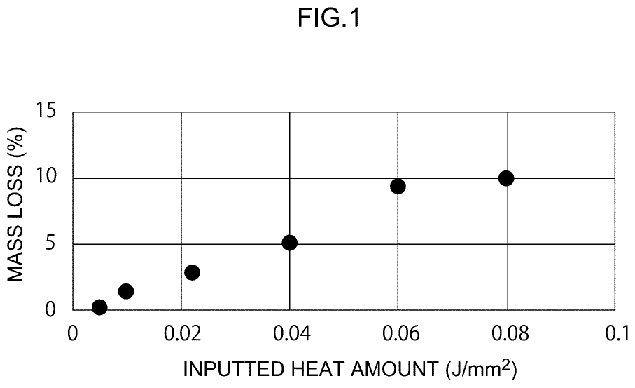

In each of the Examples and Comparative Examples, the change in mass (mass loss (%)) of the active material layer before and after the irradiating of the nanosecond pulsed laser was measured. The results are shown as a graph in FIG. 1.

As illustrated by the graph of FIG. 1, the results were that, in Example 1 (inputted heat amount: 0.005 J/mm²), Example 2 (0.01 J/mm²), Example 3 (0.022 J/mm²) and Example 4 (0.04 J/mm²), the mass loss of the active material layer was kept to less than or equal to 6%, whereas in Comparative Example 1 (inputted heat amount: 0.06 J/mm²) and Comparative Example 2 (0.08 J/mm²), the mass loss of the active material layer greatly exceeded 6%.

### (2) Battery Resistance

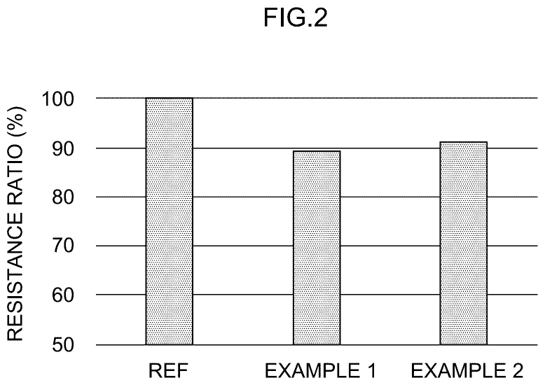

Batteries were produced by using the active material layers of Example 1 and Example 2 whose mass losses were low, and a test was carried out on the battery resistances thereof. Further, as a Reference Example (Ref), a battery resistance test was carried out in the same way on an active material layer whose surface had not been irradiated by a nanosecond pulsed laser. The ratios (%) with respect to the Reference Example (Ref) are graphed and illustrated in FIG. 2 as results of evaluation.

Note that the structure of the batteries in the battery resistance tests was a laminated cell battery (positive electrode: 45 mm×47 mm, negative electrode: 47 mm×49 mm).

As shown by the graph of FIG. 2, it can be understood that, in Example 1 and Example 2, the battery resistance could be reduced as compared with the Reference Example (Ref).

### (3) Average Particle Diameter of Binder

With respect to Example 1 and the above-described Reference Example (Ref), the average particle diameter of the binder in an image of the surface that was acquired by EPMA mapping obtained with staining the binder, was measured.

Osmium (Os) staining was carried out on the active material layers in Example 1 and the Reference Example, and EPMA (Electron Probe Micro Analysis) mapping images of the surfaces of the active material layers after the staining were obtained. Data of the luminance that was the highest 10% was computed from the mapping image, and binarization processing was carried out by setting this luminance data as the threshold value. Measuring of the particle diameters (lengths of the longest portions) of the binder (SBR) particles from the image after the binarization was carried out on 20 binder particles, and the arithmetic mean value thereof was used as the average particle diameter. The results are as follows.

### Average Particle Diameter

| | |
|---|---|
| Example 1: | 35 μm |
| Reference Example (Ref): | 17 μm |

What is claimed is:

1. A method of manufacturing an active material layer for a battery, the method comprising:
preparing an active material layer, the active material layer containing a binder and an active material; and
irradiating a nanosecond pulsed laser onto the active material layer under a condition of an inputted heat amount being greater than or equal to 0.005 J/mm² and less than or equal to 0.050 J/mm².

2. The method of claim 1, wherein the irradiating step includes irradiating a nanosecond pulsed laser under conditions of output power being greater than or equal to 1.25 W and less than or equal to 5 W, and an overlap ratio being greater than or equal to 0% and less than or equal to 63%.

3. An active material layer for a battery, the active material layer containing a binder and an active material,
wherein an average particle diameter of the binder in an image of a surface that is acquired by EPMA mapping obtained with staining the binder is greater than an average particle diameter of the binder in an image of a cross-section of a depth of 20 μm that is acquired by EPMA mapping.

4. An active material layer for a battery, the active material layer containing a binder and an active material,
wherein an average particle diameter of the binder in an image of a surface that is acquired by EPMA mapping obtained with staining the binder is greater than or equal to 30 μm.

5. A battery comprising the active material layer for a battery of claim 3 as at least one of a positive electrode active material layer or a negative electrode active material layer.

6. A battery comprising the active material layer for a battery of claim 4 as at least one of a positive electrode active material layer or a negative electrode active material layer.
